(19) United States
(12) Patent Application Publication
(10) Pub. No.: US 2012/0089571 A1
(43) Pub. Date: Apr. 12, 2012

(54) COMPUTER PROCESS MANAGEMENT

(76) Inventors: Shane Andrew Mercer, Wellington (NZ); Lindsay Ian Smith, Wellington (NZ); Nicholas Francis Clarke, Wellington (NZ)

(21) Appl. No.: 13/375,898

(22) PCT Filed: Jun. 21, 2010
(86) PCT No.: PCT/NZ10/00114

§ 371 Date: Dec. 2, 2011

Related U.S. Application Data
(60) Provisional application No. 61/218,411, filed on Jun. 19, 2009.

(51) Int. Cl. G06F 7/00

(52) U.S. Cl. 707/639; 707/E17.044

(57) ABSTRACT

A computer implemented process is defined to operate on three types of objects: Task Objects, Resume Objects, and State Objects. To define a Task Objects are implemented to perform the actions required to complete a particular aspect of the process. A State Object maintains information about the currently executing process, such as the values of variables and the current location in the executing process. A Resume Object directs process execution by specifying which Task Objects or Resume Objects to execute next. A key aspect of the system is the ability to suspend execution at any time and seamlessly resume execution at either the exact point execution was stopped or at any execution point prior to suspension. This accomplished by periodically storing Snapshots of the execution to persistent storage, which can later be used to restore the state of the system to that of the Snapshot.

### CROSS REFERENCE TO RELATED APPLICATIONS

This application claims the benefit of U.S. Provisional Patent Application No. 61/218,411 entitled “COMPUTER PROCESS MANAGEMENT” filed on Jun. 19, 2009, and which is hereby expressly incorporated herein by reference in its entirety.

### BACKGROUND

1. Technical Field

The present disclosure relates to the execution of a computer implemented process and more specifically to the execution of a computer implemented process that can be suspended and subsequently resumed from any point in the process.

2. Introduction

Computer implemented processes typically comprise a series of discrete steps performed sequentially to complete a desired task. As a process executes it moves data around, both within the system and in and out of the system, and it modifies data within the system. Depending on the action taken, the state of the data on a previous step could be destroyed by a subsequent step. This loss of data relating to prior states makes it very difficult, and in some cases impossible, for the process to be restarted or to revert to an earlier status or point in the process. A process is therefore usually only able to be carried out once, from the point at which the process was suspended. It is not possible for a process to be reinstated multiple times from a particular execution point, nor reinstated using a discrete or separate copy of the information used in the process. The inability to recreate and reinstate a process from an arbitrary point in the process makes it very difficult to reproduce failures. This in turn makes it time consuming and costly to identify the cause of the failure and fix it.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein are systems, methods, and non-transitory computer-readable storage media for executing a computer implemented process. A Computer Process Management (CPM) System resides on a general purpose computing device and is composed of user defined computer implemented processes. To define a process a user implements one or more Task Objects. The modularity of the CPM System allows the user to divide a process into individual tasks that can each be implemented in a Task Object. Furthermore, because a task could be accomplished via sub-tasks, a Task Object can be a collection of other Task Objects. A Task Object specifies a single “execute” function that performs the actions required to complete a particular aspect of the process. The “execute” function can be implemented using any programming language or the system could be pre-configured with a set of building block Task Objects that a user can use to build their own Task Objects. Any Task Object defined by the user can be stored in the CPM System to be used by the user in a later process. The Task Object's “execute” function has a single input parameter: a State Object. The Task Object can either perform its task by interacting with the State Object or some external system (e.g. a database).

A State Object maintains information about the currently executing process. A State Object is divided into three sections: Application Data, Context Data, and Execution Data. The currently executing Task Object uses the Application Data section for storing data that would be stored on the stack or heap in a traditional execution environment. For example, if the operation is storing a value to a local variable, the variable would be allocated space in the Application Data section and the value is stored to that location. This facilitates passing data from one Task Object to another. The Execution Data section contains a stack to maintain the current location in the executing process, i.e. what Resume Object is currently executing and which ones the system knows still need to be executed. Finally, the Context Data section stores contextual information about the process such as initial parameters and/or properties of the agent that initiated the process.

A Resume Object is responsible for directing process execution. It is the Resume Objects that are pushed onto the Execution Data Stack in the State Object. A Resume Object specifies a single “resume” function that defines what action is to be taken to resume, or continue, execution. This can be accomplished by specifying Task Objects or other Resume Objects to execute next. In other words, the CPM System can be viewed as entering a suspend state each time a Resume Object completes execution. The next Task Object is only executed once a Resume Object directs the system to execute a particular Task Object.

A key aspect of the CPM System is the ability to suspend execution at any time and seamlessly resume execution at either the exact point execution was stopped or at any execution point prior to suspension. This is accomplished by periodically storing the State Object and all of its contents, including Resume Objects, to persistent storage such as a hard drive. This record of a State Object from some point in time is known as a Snapshot. When stored, the Snapshot is assigned a unique identifier that can be used for later retrieval. When a Snapshot is retrieved, call the “resume” function on the top most Resume Object in the Execution Data stack restarts the process from the point in time that the State Object was captured.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment;

FIG. 2 illustrates an exemplary method embodiment;

FIG. 3 illustrates an outside process making a request to the Control Process Management System;

FIG. 4 illustrates a detailed view of an exemplary computer implemented process for the Control Process Management System; and

FIG. 5 illustrates an exemplary evolution of a State Object in the Control Process Management System.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

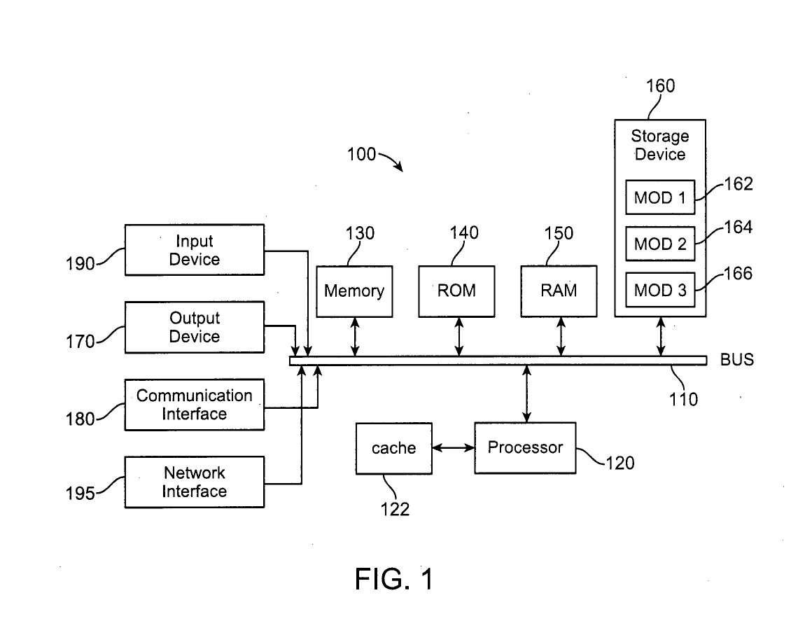

The present disclosure addresses the need in the art for a method of executing computer implemented processes that can be suspended and subsequently resumed from any point in the execution. The disclosure first sets forth a discussion of a basic general purpose system or computing devices in FIG. 1 that can be employed to practice the concepts disclosed herein. Next the disclosure turns to a brief discussion of executing a computer implemented process on a general purpose computing device. The disclosure then proceeds with an exemplary method embodiment and two illustrative examples.

With reference to FIG. 1, an exemplary system 100 l includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMS) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some basic system components, the disclosure now turns to a brief discussion of executing a computer implemented process on a general purpose computing device using the disclosed Computer Process Management (CPM) System. A CPM System resides on a general purpose computing device such as system 100 in FIG. 1 and is composed of user defined computer implemented processes. To define a process a user implements one or more Task Objects. The modularity of the CPM System allows the user to divide a process into individual tasks that can each be implemented in a Task Object. Furthermore, because a task could be accomplished via sub-tasks, a Task Object can be a collection of other Task Objects. To illustrate, a Task Object can define some low level task such as computing the arithmetic sum of two number, or may be a high level task such as “Enter customer details,” which involves displaying a GUI to the user and processing the user input, and therefore, a Task Object can be defined of multiple simpler Task Objects. For example, the “Enter customer details” task can be implemented as a sequence of the following individual tasks: (1) display customer list to user to enable selection of a customer; (2) retrieve selected customer details; (3) display customer details screen for editing; and (4) save customer details. A Task Object designed for the specific task can implement each of these sub-tasks.

A Task Object specifies a single “execute” function that performs the actions required to complete a particular aspect of the process. The “execute” function can be implemented using any programming language or the system could be pre-configured with a set of building block Task Objects that a user can use to build their own Task Objects. Any Task Object defined by the user can be stored in the CPM System to be used by the user in a later process. The Task Object's “execute” function has a single input parameter: a State Object. The Task Object can either perform its task by interacting with the State Object or some external system (e.g. a database).

A State Object maintains information about the currently executing process. A State Object is divided into three sections: Application Data, Context Data, and Execution Data. The currently executing Task Object uses the Application Data section for storing data that would be stored on the stack or heap in a traditional execution environment. For example, if the operation is storing a value to a local variable, the variable would be allocated space in the Application Data section and the value is stored to that location. This facilitates passing data from one Task Object to another. The Execution Data section contains a stack to maintain the sequence of execution in the executing process, i.e. what Resume Object is currently executing and which ones the system knows still need to be executed. It can also contain stacks for storing information about the current location in the executing process, such as the last Task Object executed by a Resume Object. Finally, the Context Data section stores contextual information about the process such as initial parameters and/or properties of the agent that initiated the process.

A Resume Object is responsible for directing process execution. It is the Resume Objects that are pushed onto the Execution Data Stack in the State Object. A Resume Object specifies a single “resume” function that defines what action is to be taken to resume, or continue, execution. This can be accomplished by specifying Task Objects or other Resume Objects to execute next. In other words, the CPM System can be viewed as entering a suspend state each time a Resume Object completes execution. The next Task Object is only executed once a Resume Object directs the system to execute a particular Task Object.

A key aspect of the CPM System is the ability to suspend execution at any time and seamlessly resume execution at either the exact point execution was stopped or at any execution point prior to suspension. This is accomplished by periodically storing the State Object and all of its contents, including Resume Objects, to persistent storage such as a hard drive. This record of a State Object from some point in time is known as a Snapshot. When stored, the Snapshot is assigned a unique identifier that can be used for later retrieval. When a Snapshot is retrieved, call the “resume” function on the top most Resume Object in the Execution Data stack restarts the process from the point in time that the State Object was captured.

A CPM System receives a request to execute a user defined process from another process executing on the system 100, via the communications interface 180, or from another device connected to the system 100 through the network interface 195. Upon receiving the request the CPM System initializes the process by creating the State Object, storing any supplied information to the Context Data section of the State Object and pushing the appropriate Resume Objects on the Execution Data Stack in the State Object.

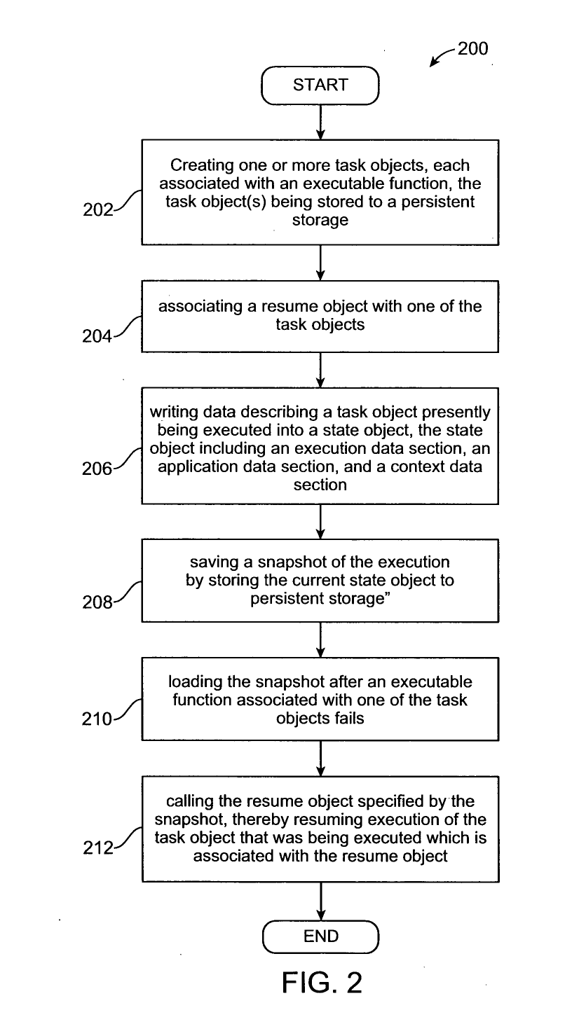

Having disclosed some basic system components, the disclosure now turns to the exemplary method embodiment 200 shown in FIG. 2. For the sake of clarity, the method is discussed in terms of an exemplary system such as is shown in FIG. 1 configured to practice the method. FIG. 2 illustrates an exemplary method embodiment for creating and executing a computer implemented process. A suitably configured system 100 can perform any and/or all of the steps of the method. Although specific steps are shown in FIG. 2, in other embodiments a method can have more or less steps than shown. First, the system 100 creates one or more Task Objects, each associated with an executable function, the Task Object(s) being stored to a persistent storage (202). In some embodiments, the system 100 creates a Task Object by selecting a Task Object that was previous defined and stored in persistent storage. In some embodiments, the system 100 creates a Task Object based on specifications provided by the user.

The Task Object can be the implementation of one or more operations required to carry out a process. The operations are specified within the associated executable function. As described above, the executable function performs the task it was designed for by interacting with the supplied State Object or some external system, if needed. For example, the executable function can retrieve variables from the State Object or it could access an external storage device to retrieve the necessary values. The executable function can also store values to the State Object so that other Task Objects can use the values or it can store values to an external storage device.

In some embodiments, a process can be implemented using only a single Task Object or the process can be divided and multiple Task Objects can be used. In some embodiments, instead of a Task Object specifying a set of computer operations that achieved a desired task, the Task Object can specify a set of Task Objects.

After creating a Task Object, it is stored to persistent storage. The persistent storage can be any storage in which the Task Object will still be accessible after execution of the Task Object, or even the CPM System, has ended. Examples of suitable persistent storage are an internal hard disk, an external hard disk connected to the system 100, or some other external storage device connected to the system 100.

The system 100 also associates a Resume Object with one of the Task Objects (204). As described above, the Resume Objects direct the execution of the computer implemented process through the associated Task Objects. In some embodiments, a Resume Object has an associated function. This function specifies one or more associated Task Objects and the order in which they should be executed. A Resume Object can also specify one or more Resume Objects that should be executed. In some embodiments, the Resume Objects are stored to persistent storage like that used for the Task Objects described above.

As the process executes, the system 100 writes data describing a Task Object presently being executed into a State Object, the State Object can include an Execution Data section, an Application Data section, and a Context Data section (206). As described above, The State Object is used to hold information about the currently executing process. All executed Task Objects and Resume Objects must be passed a State Object when they execute. All operations that form part of the overall process of the system are defined in terms of modifications to the. State object rather than to an implicit stack or heap, which is what is used in traditional computer implemented process execution.

The State Object can include three data sections: Execution Data, Application Data, and Context Data. In some embodiments, the Execution Data section includes a stack that maintains the current location in the execution by storing the Resume Objects in such a manner that the top Resume Object is the next one that should be executed. Execution can progress by popping a Resume Object from the stack and then executing it. In some embodiments the Execution Data stack can be initialized with the Resume Objects at the beginning of the process. In some embodiments, Resume Objects can be added to the stack during execution. For example, if a Resume Object specifies a sequence of other Resume Objects, those Resume Objects can be added to the top of the stack and execution can continue by popping a new Resume Object from the stack.

The Application Data section can be a place to store data pertaining to the process that is currently executing. In some embodiments, Application Data can take the form of simple values such as text or number, or it can be more complex data such as structured tabular data resulting from a database query. In some embodiments, if a Task Object draws data from an external system then that data can be stored in the Application Data section so that it can be accessed by subsequent Task Objects. For example, a Task Object can be designed to calculate the sum of two numbers. For the result of this calculation to be accessible by subsequent Task Objects in the process, the result is stored in the State Object, which can be passed to those subsequent Task Objects when they are executed. As another example, the process can draw data from an external system such as retrieving data from a database via a query. A Task Object that performs this action can store the resulting set of data in the State Object so that subsequent Task Objects can access it without having to query the database again.

The Context Data section can be a place store data pertaining to the conditions under which the process was begun and information regarding the identity of the agent that initiated the process. For example, execution of the process may require some initial input parameters. These parameters can be stored in the Context Data section of the State Object. Alternatively, if the execution was initiated through some external system, such as a web server, the Context Data can provide access to the system through which execution was invoked. In the case of a web server, the details of the web request can be accessible this way. Task Objects can use this information to provide a response to the request, such as formatting the response in HTML that can be displayed on a web page. In some embodiments, the Context Data can include information pertaining to the identity of the agent such as authentication information.

Periodically, as the process executes, the system 100 saves a Snapshot of the execution by storing the current State Object to persistent storage (208). In some embodiments, the system 100 can be configured to automatically save a Snapshot at specified intervals. For example, a Snapshot can be saved after the completion of each Task Object or Resume Object. Alternatively, a Snapshot can be saved after a specified number of seconds. In some embodiments, the system 100 can be configured to receive a save command and then save a Snapshot to persistent storage. In some embodiments, a unique ID is associated with each saved Snapshot so that it can easily be identified and retrieved at a later point in time.

At some later point, after an executable function associated with one of the Task Objects fails, the system 100 loads the Snapshot that was saved to persistent storage in step 208 (210). In some embodiments, the Task Object can fail through the user suspending the execution. The system 100 can load any previously saved Snapshots, not just the most recently saved Snapshot. In some embodiments, the system 100 can even load Snapshots that were saved on a different system and transferred to the system 100. In some embodiments, the same Snapshot can be loaded multiple times without damaging the original saved Snapshot.

After loading the Snapshot in step 210, the system 100 calls the Resume Object specified by the Snapshot, thereby resuming execution of the Task Object that was being executed and which is associated with the Resume Object (212). Since the State Object contains all information necessary to continue execution from the stored point, execution can continue as if it had never been suspended.

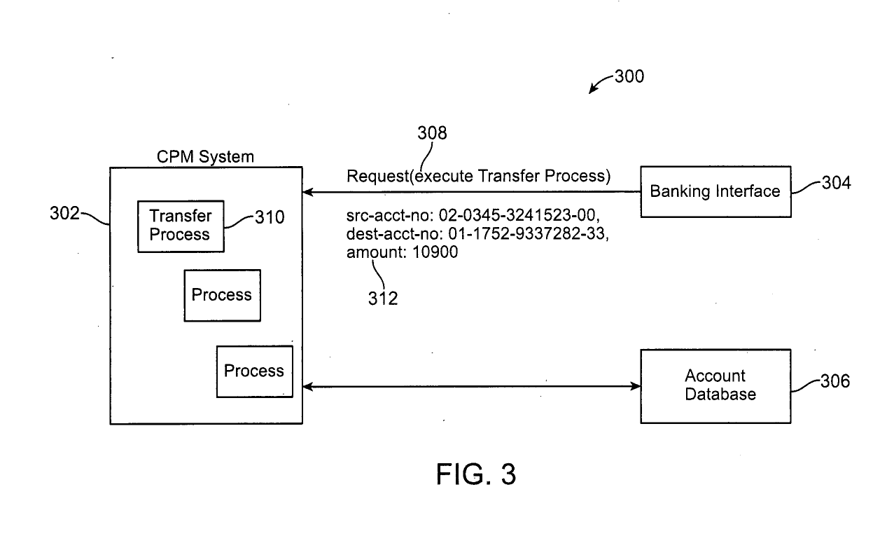

The disclosure now turns to the first of two illustrative examples. The first example is illustrated in FIG. 3. In this example, the CPM System executes a computer implemented process to transfer money between two bank accounts. In FIG. 3, the CPM System 302 receives a request 308 from the Banking Interface 304 to execute the Transfer Process 310. As part of the request the Banking Interface 304 supplies a set of input parameters 312, which include the source account number, the destination account number, and the transfer amount.

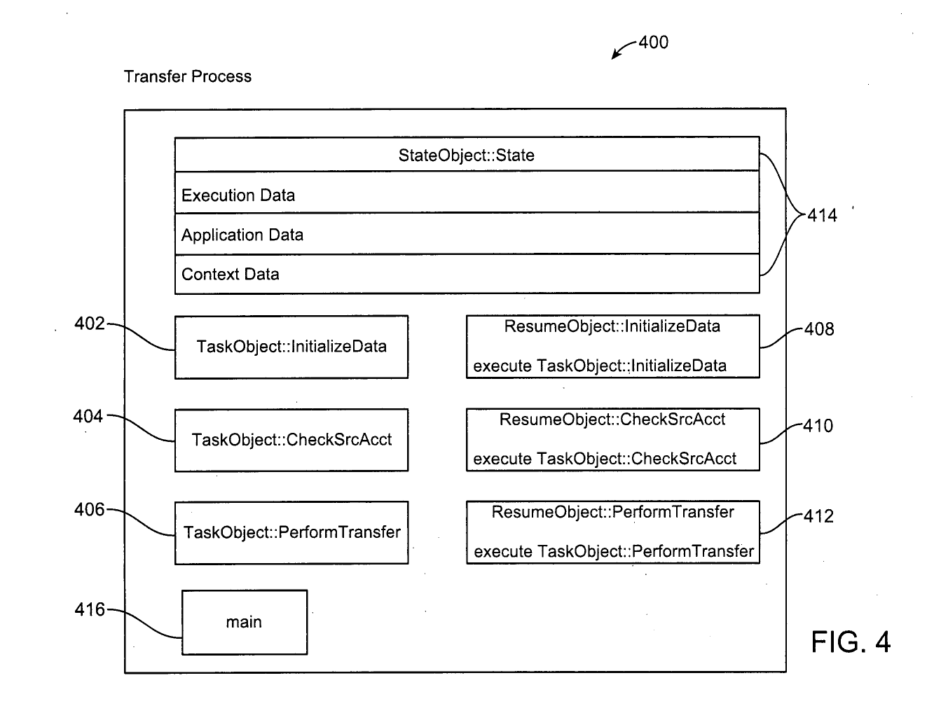

The detailed illustration of the Transfer Process 400 in FIG. 4 shows that the process includes three TaskObjects (402, 404, 406), three ResumeObjects (408, 410, 412), one StateObject (414), and a main function 416. When the CPM System 302 executes the Transfer Process 310, the main function 416 is called. In this money transfer example, pseudo code for the main function can be the following:

begin main
// Store the input information to the Context Data
State.contextData.contextInfo.put(“src-acct-no”, “02-0345-3241523-00”)
State.contextData.contextInfo.put(“dest-acct-no”, “01-1752-9337282-33”)
State.contextData.contextInfo.put(“amount”, “10900”)
// Initialize the Execution Data Stack
State.executionData.stack.push(ResumeObject::PerformTransfer)
State.executionData.stack.push(ResumeObject::CheckSrcAcct)
State.exeuctionData.stack.push(ResumeObject::InitializeData)
while not state.executionData.stack.isEmpty

nextResumeObject = State.executionData.stack.pop( )
nextResumeObject.resume(state)

end while
end main

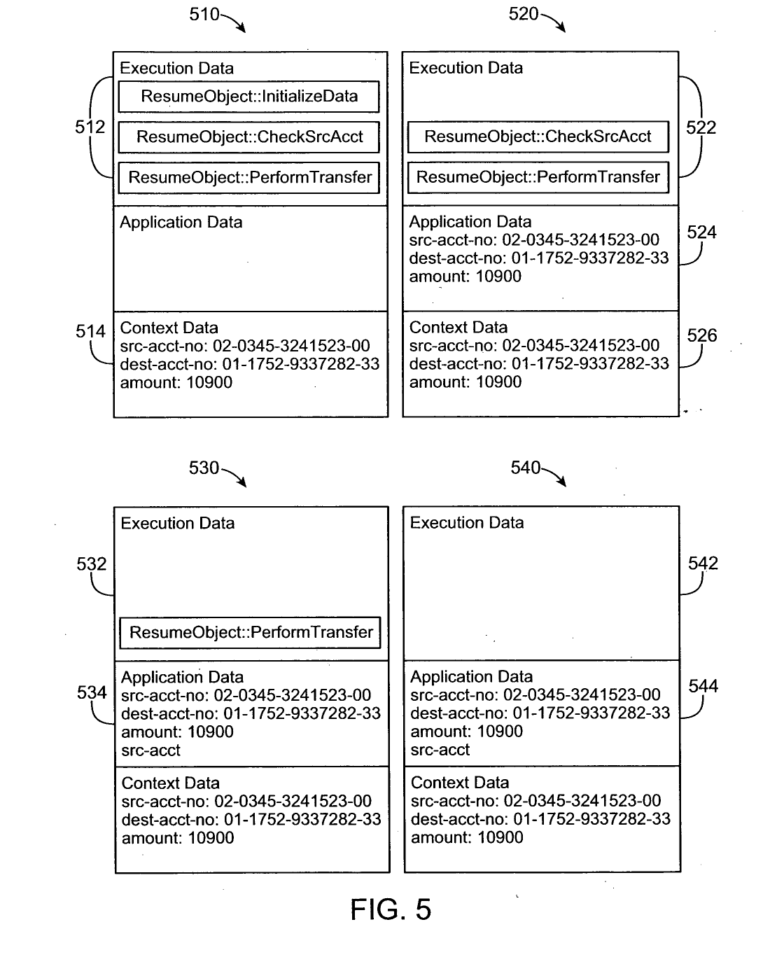

The main function performs a series of actions that initialize the StateObject State 414 so that it contains the necessary information to begin executing the Resume and Task Objects. These updates are reflected in the StateObject 510 in FIG. 5. First, the input parameters are stored to the Context Data section 514. Then the stack in Execution Data section 512 is initialized with the three ResumeObjects (408, 410, 412). The stack initialization is performed in such a manner that the ResumeObject on the top of the stack is the one that should be executed first and the one at the bottom of the stack should be executed last. After initialization, the main function continues to pop Resume Objects from the stack in the Execution Data section until it is empty.

The first Resume Object popped from the stack is the ResumeObject::InitializeData 408. Resume Object 408 instructs the CPM System 302 to execute the Task Object TaskObject::InitalizeData 402. The task performed by Task Object 402 can be illustrated through the following pseudocode:

begin execute
srcAcctNo = State.contextData.contextInfo.get(“src-acct-no”)
destAcctNo = State.contextData.contextInfo.get(“dest-acct-no”)
amount = State.contextData.contextInfo.get(“amount”)
State.applicationData.dataValues.put(“src-acct-no”, srcAcctNo)
State.applicationData.dataValues.put(“dest-acct-no”, destAcctNo)
State.applicationData.dataValues.put(“amount”, amount)
end execute

Task Object 402 acts on State Object State 510 to transform it to State Object State 520, by obtaining the input parameters from the Context Data section 526 and storing them to the Application Data section 524. This action makes the input parameters accessible to other Task Objects as the Transfer Process 310 executes.

At this point in the execution, the stack in the Execution Data section 522 still has two Resume Objects so the CPM system 302 pops ResumeObject::CheckSrcAcct 410 from the top of the stack. Resume Object 410 directs the CPM System 302 to execute the Task Object TaskObject::CheckSrcAcct 404. The task performed by Task Object 404 can be illustrated through the following pseudocode:

begin execute
srcAcctNo = State.applicationData.dataValues.get(“src-acct-no”)
transferAmount = State.applicationData.dataValues.get(“amount”)
srcAcct = retrieveBankAcct(srcAcctNo)
if srcAcct.availableBalance < transferAmount

error “Source account does not have sufficient funds”

end if
State.applicationData.dataValues.put(“src-acct”, srcAcct)
end execute

The Task Object 404 retrieves the source account from the Account Database 306 and checks to make sure it contains sufficient funds. If the account has insufficient funds for the transfer the CPM System 302 will issue an error and the Transfer Process 310 will be aborted. If there are sufficient funds, Task Object 404 will act on State Object 520 by saving the source account to the Application Data section 534. This action yields State Object 530.

Again, the stack in the Execution Data 532 is not empty, so another Resume Object is popped from the top of the Stack. This time Resume Object ResumeObject::PerformTransfer 412 is popped. Resume Object 412 directs the CPM System 302 to execute the Task Object TaskObject::PerformTransfer 406. Task Object 406 performs the actual transfer of money from the source account to the destination account, which is reflected in the following pseudocode:

begin execute
destAcctNo = State.applicationData.dataValues.get(“dst-acct-no”)
destAcct = retrieveBankAccount(dstAcctNo)
srcAcct = State.applicationData.dataValues.get(“src-acct”)
transferAmount = State.applicationData.dataValues.get(“amount”)
srcAcct.availableBalance := srcAcct.availableBalance − transferAmount
destAcct.availableBalance := destAcct.availableBalance + transferAmount
storeBankAccount(srcAcct)
storeBankAccount(dstAcct)
end execute

First, the CPM System 302 retrieves the destination account from the Account Database 306. Then using the source account and the transfer amount saved in the Application Data section 544, the source account balance is deducted. Next, the destination account is credited with the transfer amount. Finally, the source and destination accounts are stored back to the Account Database 306. At this point the stack in the Execution Data 542 is empty, so the Transfer Process is complete.

The second example illustrates the suspend and resume features of a CPM System to allow inspection of a process during execution. One of the advantages of the suspend and resume features is that they make it easy to enable debugging. To implement a debugging process in a CPM System, the user can create a main function that executes a loop. For example, pseudocode below could be used for a debugging process:

```
begin main
  // Setup the process that we want to debug.
processToDebug = retrieveProcessToDebug( )
startProcess(processToDebug)
  // Create a list of the stored State Object IDs so we can go back through
  them
  snapshotHistoryList = new List( )
  // Store a Snapshot before any execution takes place
initialSnapshotID = storeSnapshot(stateObject)
snapshotHistoryList.add(initialSnapshotID)
// The current suspended state
currentSnapshotID = initialSnapshotID
begin loop
```

// The user chooses the next thing to do
command = waitForUserCommand( )
if command = “show state”

currentSnapshot = retrieveSnapshot(currentSnapshotID)
showStateInfoToUser(currentSnapshot.state)

else if command = “run”

currentSnapshot = retrieveSnapshot(currentSnapsotID)
executeOneResumeObject(currentSnapshot)
// Store a Snapshot
newSnapshotID = storeSnapshot(stateObject)
snapshotHistoryList.add(newSnapshotID)
currentSnapshotID = newSnapshotID

else if command = “back”

snapshotID = snapshotHistoryList.lastItem( )
snapshotHistoryList.removeLastItem( )
currentSnapshotID = snapshotID

else if command = “quit”

break

end if

end loop
end main

The debugging process begins by querying the user to determine what process the user would like to debug. Then the CPM System performs the initialization, which includes storing any necessary information to the State Object, such as the input parameters to the Context Data section and pushing the Resume Objects on the stack in the Execution Data section. Next a list is created to store the IDs associated with each saved Snapshot. This list facilitates the ability to resume execution at any previous point in the execution. Prior to entering the main execution loop a Snapshot of the initial state is saved to persistent storage and the Snapshot ID is stored to the history list. This initial Snapshot will allow the user to start the process from the beginning without restarting the debugger.

After the initial setup, the debugging process enters a loop that prompts the user to chose one of four actions: run, back, show state and quit. In this example debugger, the run option retrieves the Snapshot associated with the currentSnapshotID and executes a single Resume Object. As described above, the Resume Object can direct the CPM System to execute one or more Task Objects, so the number of tasks executed on a single run step is dictated by the granularity of the Resume Object as the user designed it. However, a different level of granularity can be achieved through an alternative debugger implementation. After executing the single Resume Object, a new Snapshot is captured and saved to persistent storage. The save operation generates a snapshot ID that gets added to the history list and is used as the value for the currentSnapshotID.

The back option enables the user to backup to any previous point in the execution and then resume execution from that point. This option is not generally available in debuggers that destroy the previous state as execution progresses. However, since the CPM system can periodically capture state and store it to persistent storage, a previous state can be restored and execution can resume from that point. In this example debugger, the option works by removing the last snapshot ID added to the history list and setting that to the currentSnapshotID. If the user wants to back up more than one snapshot then the back option is repeated selected until the desired place in execution is selected. However, the debugger could also be implemented in a manner that would allow the user to back up n steps in a single action instead of having to repeatedly select the back option. To resume execution from the selected snapshot the user selects the run option.

The show state option displays the contents of the current State Object, that is the state associated with the currentSnapshotID. This option could be implemented to display all three sections of the State Object, or just the Application Data section. Alternatively, this option could have sub-options so that the user could examine a particular section of the State Object. This option is similar to options in other debuggers that allow the user to examine the contents of the stack or memory as the program executes.

Finally, the quit option is used to completely exit the debugging process. It should be noted that even after quitting the debugging process the saved Snapshots are not lost. Because the Snapshots are saved in persistent storage, the user could restart the debugger and resume debugging the previous process using the saved Snapshots. Alternatively, if the user suspects that the failure is resulting from the configuration of the computing device and not the process, the saved Snapshots could be transferred to another computing device and debugging could resume on that device using the saved Snapshots.

In addition to using the CPM System to enable debugging, it can easily be used to capture data about process execution. For example, data can be captured that measures the number of times that a Task Object was executed, or the duration of execution of a Task Object or a set of Task Objects. This data could be used to report and optimize the time spent on business tasks implemented using the CPM System.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computer implemented method comprising: creating one or more task objects, each associated with an executable function; saving the task object(s) to a persistent storage; associating a resume object with one of the task objects; writing data describing a task object presently being executed into a state object, the state object including an execution data section, an application data section, and a context data section; saving a snapshot of the execution by storing the current state object to persistent storage; loading the snapshot after an executable function associated with one of the task objects fails; and calling the resume object specified by the snapshot, thereby resuming execution of the task object that was being executed which is associated with the resume object.

2. The method of claim 1, wherein the execution data section includes a stack.

3. The method of claim 1, wherein writing data describing a task object presently being executed into a state object includes writing data used by the task object presently being executed in the application data section of the state object.

4. The method of claim 1, wherein the context data section is used to store one or more initial parameters for the computer implemented process.

5. The method of claim 1, where the context data section stores properties of an agent that initiated the computer implemented process.

6. A computer-implemented method comprising: receiving an association of an execute function with a task object, storing data describing the presently executing task object as a state object, defining a resume object, the resume object specifies the task object to be executed; executing the resume object; storing a snapshot to a persistent storage device, the snapshot including data describing the current state object; and assigning a unique identifier to the snapshot.

7. The method of claim 6, wherein the function comprises an application or a routine within an application.

8. The method of claim 6, wherein the state object includes application data, context data, and execution data related to the task object.

9. The method of claim 6, wherein the task object stores data related to its execution to the state object.

10. The method of claim 6, further comprising: resuming execution of a process by loading the snapshot identified by the unique identifier; and calling the resume object specified by the snapshot.

11. The method of claim 6, wherein the task object receives the state object as an input parameter.

12. The method of claim 6, wherein the task object interacts with an external system.

13. A computer-readable medium comprising computer-readable code stored on the computer-readable medium for causing a computer to perform the method of claim 1.

14. A device comprising: a processor configured to execute a task object, the task object being associated with a resume object; and a persistent storage configured to store a snapshot of the presenting operating condition of the task object, the snapshot comprising a state object, the state object including an execution data section, an application data section, and a context data section; the processor further configured to load the snapshot after execution of the task object fails and to resume the execution of the process as specified by the resume object.

15. The device of claim 14, wherein the processor is further configured to supply the state object as input into the resume object upon resumption of the execution of the resume object.
